(19) United States
(12) Patent Application Publication
(10) Pub. No.: US 2011/0050110 A1
(43) Pub. Date: Mar. 3, 2011

(54) APPARATUS AND METHOD OF DRIVING LED, SYSTEM FOR DRIVING LED USING THE SAME, AND LIQUID CRYSTAL DISPLAY APPARATUS INCLUDING THE SYSTEM

(76) Inventor: Hee-seok Han, Hwaseong-si (KR)

(21) Appl. No.: 12/815,020

(22) Filed: Jun. 14, 2010

(30) Foreign Application Priority Data
Sep. 1, 2009 (KR) 10-2009-0081977

(51) Int. Cl. H05B 37/02

(52) U.S. Cl. 315/185 R; 315/250

(57) ABSTRACT

The light emitting diode (LED) driving apparatus includes a channel driving unit configured to detect a pulse width of a pulse width modulation (PWM) signal, and configured to output n dimming signals, where n is a natural number greater than or equal to 2. The channel driving unit is configured to sequentially shift a phase of the PWM signal by as much as the detected pulse width to generate the n dimming signals, and configured to output the n dimming signals to n channels.

### CROSS-REFERENCE TO RELATED APPLICATION(S)

This application claims the benefit of Korean Patent Application No. 10-2009-0081977, filed on Sep. 1, 2009, in the Korean Intellectual Property Office, the disclosure of which is incorporated herein in its entirety by reference.

### BACKGROUND

1. Field

Example embodiments of inventive concepts relate to controlling lighting and brightness of a light emitting diode (LED), for example, to an apparatus for and method of driving a plurality of LEDs, an LED driving system using the LED driving apparatus and method, and a liquid crystal display (LCD) apparatus including the LED driving system.

2. Description of the Related Art

Recently, demand for flat panel display apparatuses having improved characteristics such as having a thinner profile, lighter weight, and lower power consumption, has increased. In addition, since LCDs rate highly for image resolution, color display, and image quality, LCDs have been widely used as monitors in notebook computers or desktop computers. In general, since liquid crystals in LCDs do not emit light and only adjust transmittance of light, an additional light source is required in LCDs. Therefore, a backlight is disposed in a rear portion of a liquid crystal panel so that light emitted from the backlight is incident onto the liquid crystal panel, and then, an intensity of light passing through the liquid crystal panel varies depending on an alignment of the liquid crystal to display images. A cold cathode fluorescent lamp (CCFL), which is conventionally used as backlight in the LCD uses a mercury (Hg) gas which may cause environmental contamination, has a relatively low response speed and low color reproductivity, and is generally not suitable for fabricating light in relatively thin, short, and small liquid crystal panels. However, an LED is environmental-friendly, has a relatively fast response speed of a few nano-seconds, which is suitable for video signal streams, and is driven impulsively. In addition, the LED has relatively high color reproductivity, and is generally suitable for a light, thin, short, and small liquid crystal panels. Although LEDs are considered as a next generation light source because they have a lower power consumption than a conventional light source and may be permanently used, they have a relatively low brightness and are relatively expensive. However, these disadvantages have been generally addressed, and LEDs have been widely applied to variety of industrial fields. The LED's brightness has been rapidly improved due to developments of relating technologies and raw material technologies. LEDs were restrictively used as a light source of for small LCDs, such as a mobile phone. However, LEDs having high brightness/high power have been developed recently, and the color reproductivity of a LED is greater than that of conventional light sources, such as a CCFL. Thus, research for using LEDs as a light source of a backlight in large LCDs has been conducted. Therefore, LEDs have been recently used as a backlight light source in LCDs due to the above advantages.

### SUMMARY

Example embodiments of inventive concepts provide an apparatus for driving a plurality of light emitting diodes (LEDs). Example embodiments of inventive concepts also provide a method of driving a plurality of LEDs. Further, example embodiments of inventive concepts provide an LED driving system using the apparatus and method of driving an LED.

According to example embodiments of inventive concepts, the light emitting diode (LED) driving apparatus includes a channel driving unit configured to detect a pulse width of a pulse width modulation (PWM) signal, and configured to output n dimming signals, where n is a natural number greater than or equal to 2. The channel driving unit is configured to sequentially shift a phase of the PWM signal by as much as the detected pulse width to generate the n dimming signals, and configured to output the n dimming signals to n channels.

According to example embodiments of inventive concepts, an LED driving system includes the LED driving apparatus, a plurality of LEDs connected in series to each of the n channels, at least one switch configured to control a current flowing on the plurality of LEDs in response to the n dimming signals, and a power unit configured to supply the current flowing on the plurality LEDs.

According to example embodiments of inventive concepts, an LED driving method includes receiving a pulse width modulation (PWM) signal, detecting a pulse width of the PWM signal, generating n dimming signals by sequentially shifting a phase of the PWM signal by as much as the detected pulse width, where n is a natural number greater than or equal to 2, and providing n channels with the n dimming signals.

### BRIEF DESCRIPTION OF THE DRAWINGS

Example embodiments of inventive concepts will be more clearly understood from the following detailed description taken in conjunction with the accompanying drawings in which:

FIG. 1 is a graph illustrating a pulse width modulation (PWM) dimming control according to example embodiments of inventive concepts;

FIG. 2 is a block diagram of a light emitting diode (LED) driving system according to example embodiments of inventive concepts;

FIG. 3 is a timing diagram showing operations of an LED driving system when two channels are driven simultaneously;

FIGS. 4A through 4D are timing diagrams showing operations of an LED driving system when two channels are sequentially driven, according to example embodiments of inventive concepts;

FIG. 5 is a timing diagram showing operations of an LED driving system when four channels are simultaneously driven;

FIGS. 6A through 6D are timing diagrams showing operations of an LED driving system when four channels are sequentially driven, according to example embodiments of inventive concepts;

FIG. 7 is a timing diagram showing operations of an LED driving system when six channels are simultaneously driven;

FIGS. 8A through 8D are timing diagrams showing operations of an LED driving system when six channels are sequentially driven, according to example embodiments of inventive concepts;

FIG. 9 is a block diagram of an LED driving unit shown in FIG. 2, according to example embodiments of inventive concepts;

FIG. 10 is a diagram of an LED backlight unit including the LED driving system of FIG. 2, according to example embodiments of inventive concepts;

FIG. 11 is another diagram of an LED backlight unit including the LED driving system of FIG. 2, according to example embodiments of inventive concepts;

FIG. 12 is yet another diagram of an LED backlight unit including the LED driving system of FIG. 2, according to example embodiments of inventive concepts;

FIG. 13 is still another diagram of an LED backlight unit including the LED driving system of FIG. 2, according to example embodiments of inventive concepts;

FIG. 14 is yet another diagram of an LED backlight unit including the LED driving system of FIG. 2, according to example embodiments of inventive concepts;

FIG. 15 is still another diagram of an LED backlight unit including the LED driving system of FIG. 2, according to example embodiments of inventive concepts; and

FIG. 16 is a block diagram of an LCD according to example embodiments of inventive concepts.

### DETAILED DESCRIPTION

The attached drawings for illustrating embodiments of inventive concepts are referred to in order to gain a sufficient understanding of inventive concepts, the merits thereof, and the objectives accomplished by the implementation of inventive concepts.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures. The figures are intended to depict example embodiments and should not be interpreted to limit the intended scope of the claims. The accompanying figures are not to be considered as drawn to scale unless explicitly noted.

The terminology used herein is for the purpose of describing particular embodiments only and is not intended to be limiting of example embodiments. As used herein, the singular foams “a”, “an” and “the” are intended to include the plural forms as well, unless the context clearly indicates otherwise. It will be further understood that the terms “comprises”, “comprising,” “includes” and/or “including”, when used herein, specify the presence of stated features, integers, steps, operations, elements, and/or components, but do not preclude the presence or addition of one or more other features, integers, steps, operations, elements, components, and/or groups thereof. In this specification, the term “and/or” picks out each individual item as well as all combinations of them.

Example embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

Now, in order to more specifically describe example embodiments, example embodiments will be described in detail with reference to the attached drawings. However, example embodiments are not limited to the embodiments described herein, but may be embodied in various forms.

When it is determined that a detailed description related to a related known function or configuration may make the purpose of example embodiments unnecessarily ambiguous, the detailed description thereof will be omitted. Also, terms used herein are defined to appropriately describe example embodiments and thus may be changed depending on a user, the intent of an operator, or a custom. Accordingly, the terms must be defined based on the following overall description within this specification.

Hereinafter, inventive concepts will be described in detail by explaining example embodiments of inventive concepts with reference to the attached drawings.

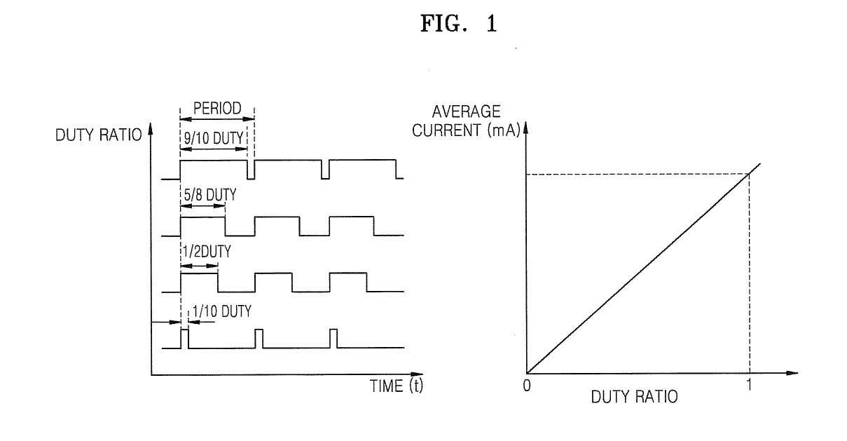

FIG. 1 is a graph illustrating a concept of pulse width modulation (PWM) dimming that adjusts a brightness of a light emitting diode (LED) by adjusting a pulse width of a square wave or a duty ratio, according to example embodiments of inventive concepts.

Referring to FIG. 1, an average current amount varies with a duty ratio of a pulse of a current flowing in an LED, for example, a width of the current pulse. The width of the current pulse denotes the flowing time of the current in the LED. According to example embodiments of inventive concepts, a PWM dimming control that changes a pulse width of a PWM signal or a duty ratio of the PWM signal is used to adjust a brightness of the LED. A duty ratio of a PWM signal is determined as a ratio of a turning-on time of the PWM signal with respect to a period of the PWM signal. Since the LED may perform turning on/turning off switching operations faster than generally other optical devices, the brightness of LED may be adjusted by varying the pulse width or the duty ratio. The brightness of LED is directly related to the current flowing in the LED, and the PWM dimming control is performed by adjusting the average current flowing in the LED. For example, as the pulse width or the duty ratio of the dimming signal increases, the flowing time of the current in the LED increases, and accordingly, the average current flowing in the LED increases, which causes an increase of the brightness of the LED. On the other hand, as the pulse width or the duty ratio of the dimming signal is reduced, the flowing time of the current in the LED is reduced, and accordingly, the average current flowing in the LED is reduced, which caused a reduction of the brightness of the LED.

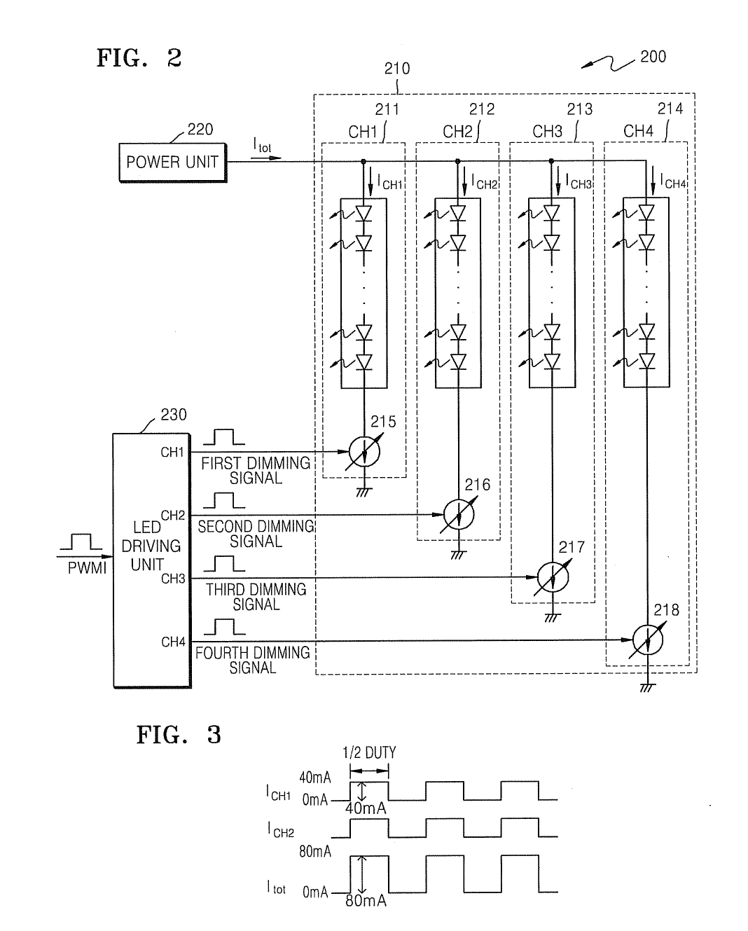

FIG. 2 is a block diagram of an LED driving system 200 according to example embodiment of inventive concepts.

Referring to FIG. 2, the LED driving system 200 includes a power unit 220, an LED array 210, and an LED driving unit 230. The LED array 210 includes four channels 211, 212, 213, and 214, and each of the channels 211, 212, 213, and 214 includes a plurality of LEDs connected in series. The channels 211, 212, 213, and 214 may respectively include switches 215, 216, 217, and 218 controlled by corresponding dimming signals. The plurality of LEDs may be connected to each other in various ways. The channels 211, 212, 213, and 214 may have the same configuration so that optical outputs generated by the channels 211, 212, 213, and 214 are consistent with each other. The LED driving unit 230 receives dimming information externally, and generates dimming signals for controlling brightness of the outputs of the channels 211, 212, 213, and 214. If it is assumed that a group of LEDs which are driven by one dimming signal is a channel, four dimming signals may be used to drive four channels 211, 212, 213, and 214. The dimming information may be received via a PWM signal. For example, the LED driving unit 230 obtains dimming information of the channel to be driven from a pulse width or a duty ratio of a PWM signal (PWMI). In addition, as described above, since the LED dimming may be controlled in the PWM method due to fast response speeds, the dimming signals (first through fourth dimming signals) controlling brightness of the channels are PWM signals. An average current flowing in each of the channels for a period is determined according to the pulse width or the duty ratio of the dimming signal (first, second, third, or fourth dimming signal). Therefore, the brightness of the four channels 211-214 is adjusted by the pulse width or the duty ratio of the dimming signals (first through fourth dimming signals).

The four dimming signals (first through fourth dimming signals) may be activated at the same time to drive the four channels 211-214 simultaneously. In this case, the current flows or does not flow in the four channels 211-214 at the same time. Therefore, a relatively large amount of electric current flows in the system 200 when the channels 211-214 are activated, and the current does not flow in the system 200 when the channels 211-214 are deactivated. Therefore, the current I_{TOT} supplied by the power unit 220 to the four channels 211-214 may rapidly change, which may cause a ripple in a voltage and current at the output end of the power unit 220. Thus, instability of the LED driving system 200 may increase. In addition, the ripple may occur in the current I_{CH1}-I_{CH4} flowing on the channels 211-214, and thus, the uniformity of the brightness of the channels 211-214 may be affected.

The LED driving unit 230 drives the four channels 211-214 with a time interval. For example, the LED driving unit 230 generates four dimming signals (first through fourth dimming signals) by sequentially shifting a phase of the PWM signal PWMI transmitted from outside as much as the pulse width or the duty ratio of the PWM signal PWMI, and supplies the generated first through fourth dimming signals as turning on/turning off controlling signals of the switches 215-218. For example, when the first dimming signal is deactivated, the second dimming signal is activated. When the second dimming signal is deactivated, the third dimming signal is activated. When the third dimming signal is deactivated, the fourth dimming signal is activated. Thus, the first through fourth dimming signals may have phase differences as much as the pulse width or the duty ratio of the PWM signal PWMI between each other, and the phase difference may vary depending on the pulse width or duty ratio of the PWM signal PWMI.

Operations of the LED driving system 200 will be described as follows, according to example embodiments of inventive concepts. The LED driving unit 230 receives the PWM signal PWMI transmitted from the outside of the LED driving system 200, and outputs the first through fourth dimming signals for controlling brightness of the channels 211-214. When the first dimming signal is activated, the first switch 215 is turned on for the time corresponding to the pulse width or duty ratio of the first dimming signal. Therefore, the power unit 220 and the first channel 211 are electrically connected to each other, and thus, an electric current I_{CH1} flows in the first channel 211 for a time period corresponding to the pulse width or duty ratio of the first dimming signal. After that, when the first dimming signal is deactivated, the first switch 215 is turned off, and then, the power unit 220 and the first channel 211 is electrically disconnected so that the current I_{CH1} does not flow in the first channel 211. At this time, the second dimming signal is activated; and the second switch 216 is turned on for a time period corresponding to the pulse width or duty ratio of the second dimming signal. Thus, the power unit 220 and the second channel 212 are electrically connected to each other so that an electric current I_{CH2} flows in the second channel 212 for the time period corresponding to the pulse width or duty ratio of the second dimming signal. After that, when the second dimming signal is deactivated, the second switch 216 is turned off, and then, the power unit 220 and the second channel 212 is electrically disconnected so that the current I_{CH2} does not flow in the second channel 212. At this time, the third dimming signal is activated, the third switch 217 is turned on for a time period corresponding to the pulse width or duty ratio of the third dimming signal. Thus, the power unit 220 and the third channel 213 are electrically connected to each other so that an electric current I_{CH3} flows in the third channel 213 for the time period corresponding to the pulse width or duty ratio of the third dimming signal. After that, when the third dimming signal is deactivated, the third switch 217 is turned off, and then, the power unit 220 and the third channel 213 is electrically disconnected so that the current I_{CH3} does not flow in the third channel 213. At this time, the fourth dimming signal is activated, the fourth switch 218 is turned on for a time period corresponding to the pulse width or duty ratio of the fourth dimming signal. Thus, the power unit 220 and the fourth channel 214 are electrically connected to each other so that an electric current I_{CH4} flows in the fourth channel 214 for the time period corresponding to the pulse width or duty ratio of the fourth dimming signal. Since the LED driving unit 230 sequentially operates the LED channels 211-214 as described above, the changing amount of the voltage and current at the output end of the power unit 220 and the ripple may be reduced to less than those when the channels are driven simultaneously.

However, example embodiments of inventive concepts are not limited to above described example, and may, for example, include a various number of channels and/or a various number of LEDs in each of the channels.

FIG. 3 is a timing diagram showing operations of an LED driving system when two channels are simultaneously driven.

Referring to FIG. 3, currents flowing in the channels and an amount of change in power current according to the currents are shown. In FIG. 3, a duty ratio of the square wave currents I_{CH1} and I_{CH2} flowing in the two channels is 1/2. Since the brightness of the channels is adjusted in the PWM dimming controlling method, the current flowing in each of the channels also has a PWM square waveform. If the current flowing in a channel is 40 mA, a total current I_{TOT} flowing in the entire channels is 80 mA for first 1/2 periods. No current flows in the remaining 1/2 period since the duty ratio is 1/2 and the number of the channels is two. Since the first and second dimming signals having the same frequency and the same duty ratio as each other are activated at the same time due to the simultaneous driving, the currents flow simultaneously in the first and second channels. Therefore, the amount of change in the power current I_{TOT} is 80 mA regardless of the duty ratio. The duty ratio shown in FIG. 3 is 1/2; however, the amount of change in the power current is also 80 mA under the other duty ratios.

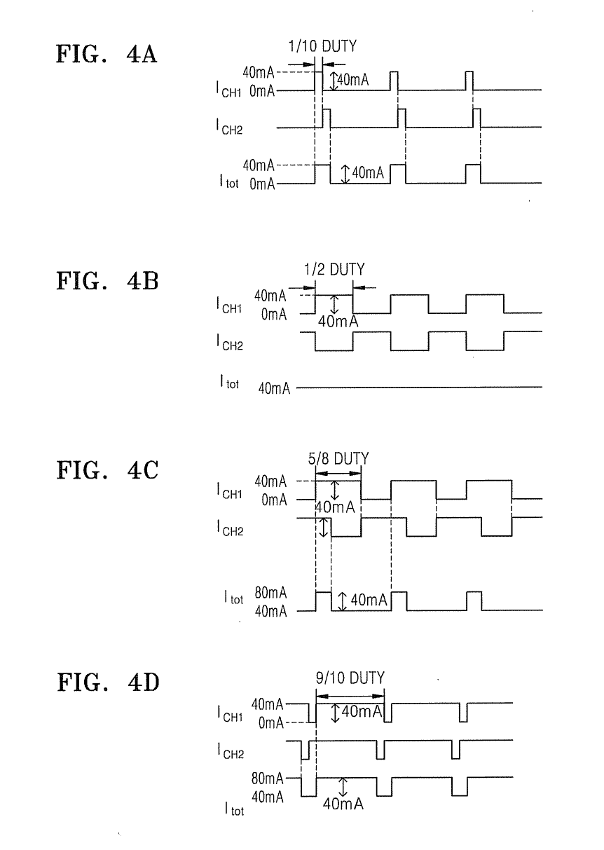

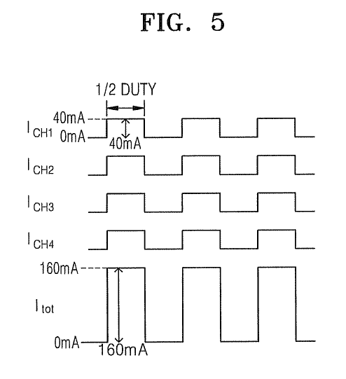

FIGS. 4A through 4D are timing diagrams showing operations of an LED driving system when two channels are driven differentially, according to example embodiments of inventive concepts.

Referring to FIGS. 4A through 4D, currents flowing in each of the channels and a changing amount of a power current according to the currents are shown. In FIGS. 4A through 4D, a duty ratio between square wave currents I_{CH1} and I_{CH2} flowing in the two channels is 1/10 (FIG. 4A), 1/2 (FIG. 4B), 5/8 (FIG. 4C), or 9/10 (FIG. 4D), for example. Since the brightness of the channels is adjusted by the PWM dimming controlling method, the current flowing in each of the channels also has a PWM square waveform. The first and second dimming signals have the same frequency and the same duty ratio as each other and a phase difference as much as the duty ratio due to the differential driving of the channels, and thus, the waveforms of the currents flowing in the first and second channels also have a phase difference as much as the duty ratio.

FIG. 4A shows a case where the duty ratio is 1/10. When a waveform of the first channel current I_{CH1} descends, a waveform of the second channel current I_{CH2} rises. If the current flowing in a channel is 40 mA, the total current I_{TOT} flowing in the entire channels is 40 mA for the first 1/5 period and 0 mA in remaining 4/5 periods since the duty ratio is 1/10 and the number of channels is two. Therefore, an amount of change in the total current I_{TOT} is 40 mA. Therefore, the amount of change in the total current is reduced by 50% compared to that when the channels are simultaneously driven.

FIG. 4B shows a case where the duty ratio is 1/2. When the waveform of the first channel current I_{CH1} descends, a waveform of the second channel current I_{CH2} rises. If the current flowing in a channel is 40 mA, the first and second channels are alternately activated so that the current flows in only one channel, and thus, the total current I_{TOT} flowing in the entire channels is 40 mA because the duty ratio is 1/2 and the number of channels is two. Therefore, an amount of change in the power current I_{TOT} is 0 mA. Therefore, the amount of change in the power current is reduced by 100%, compared to when the channels are simultaneously driven.

FIG. 4C shows a case where the duty ratio is 5/8. When the waveform of the first channel current I_{CH1} descends, a waveform of the second channel current I_{CH2} rises. If the current flowing in a channel is 40 mA, the total current I_{TOT} flowing in the entire channels is 80 mA for first 1/4 period and 40 mA in remaining 3/4 periods because the duty ratio is 5/8 and the number of channels is two. Thus, an amount of change in the power current I_{TOT} is 40 mA. Therefore, the amount of change in the power current is reduced by 50% compared to that when the channels are simultaneously driven.

FIG. 4D shows a case where the duty ratio is 9/10. When the waveform of the first channel current I_{CH1} descends, a waveform of the second channel current I_{CH2} rises. If the current flowing in a channel is 40 mA, the total current I_{TOT} flowing in the entire channels is 40 mA for first 4/5 periods and 0 mA in remaining 1/5 periods because the duty ratio is 9/10 and the number of channels is two. Thus, an amount of change in the power current I_{TOT} is 40 mA. Therefore, the changing amount of the power current is reduced by 50% compared to that when the channels are simultaneously driven.

As described above, when the two channels are driven differentially according to example embodiments of inventive concepts, the amount of change in the power current or the ripple is reduced when compared with the case when the two channels are simultaneously driven.

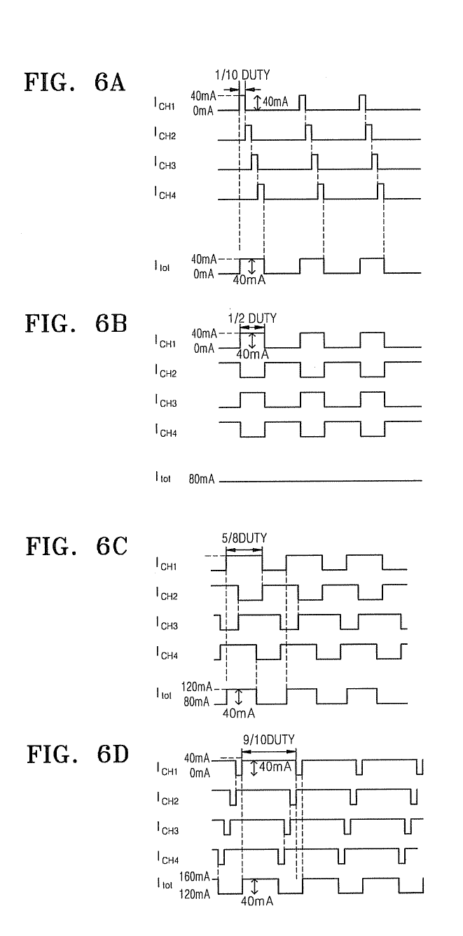

FIG. 5 is a timing diagram showing operations of an LED driving system when four channels are simultaneously driven.

Referring to FIG. 5, current flowing in each of the channels and an amount of change in the power current according to the current are shown. The duty ratio of the square wave current I_{CH1} through I_{CH4} flowing in the channels is 1/2. Since the brightness of the channels is adjusted in the PWM dimming controlling method, the current flowing in each of the channels also has a PWM square waveform. If the current flowing in a channel is 40 mA, a total current I_{TOT} flowing in the entire channels is 160 mA for first 1/2 period and 0 mA in the remaining 1/2 period since the duty ratio is 1/2 and the number of the channels is four. Since the first through fourth dimming signals having the same frequency and the same duty ratio as each other are activated at the same time due to the simultaneous driving of the channels, the currents simultaneously flow in the first through fourth channels at the same time. Therefore, the amount of change in the power current I_{TOT} is 160 mA regardless of the duty ratio.

FIGS. 6A through 6D are timing diagrams showing operations of an LED driving system when four channels are sequentially driven, according to example embodiments inventive concepts.

Referring to FIGS. 6A through 6D, current flowing in each of the channels and an amount of change in the power current according to the current are shown. In FIGS. 6A through 6D, a duty ratio of square wave currents I_{CH1} through I_{CH4} flowing in the four channels is 1/10 (FIG. 6A), 1/2 (FIG. 6B), 5/8 (FIG. 6C), or 9/10 (FIG. 6D), for example. Since the brightness of the channels is adjusted in the PWM dimming controlling method, the currents flowing in each of the channels also have a PWM square waveform. The first through fourth dimming signals having the same frequency and the same duty ratio as each other also have a phase difference as much as the duty ratio due to the differential driving of the channels, and thus, the waveforms of the currents flowing in the first through fourth channels also have a phase difference as much as the duty ratio.

FIG. 6A shows a case where the duty ratio is 1/10. When a waveform of the first channel current I_{CH1} descends, a waveform of the second channel current I_{CH2} rises, and when a waveform of the second channel current T_{CH2} descends, a waveform of the third channel current I_{CH3} rises. When a waveform of the third channel current I_{CH3} descends, a waveform of the fourth channel current I_{CH4} rises. If the current flowing in one channel is 40 mA, a total current flowing in the entire channels is 40 mA in first 2/5 periods and 0 mA in the remaining 3/5 periods since the duty ratio is 1/10 and the number of the channels is four. Therefore, the amount of change in the power current I_{TOT} is 40 mA. Thus, the amount of change in the power current is reduced by 75% compared to that when the channels are simultaneously driven.

FIG. 6B shows a case where the duty ratio is 1/2. When a waveform of the first channel current I_{CH1} descends, a waveform of the second channel current I_{CH2} rises, and when a waveform of the second channel current I_{CH2} descends, a waveform of the third channel current I_{CH3} rises. When a waveform of the third channel current I_{CH3} descends, a waveform of the fourth channel current I_{CH4} rises. If the current flowing in one channel is 40 mA, the duty ratio is 1/2 and the number of channels is four, and accordingly, waveforms of the currents flowing in odd-numbered channels or in even-numbered channels have the same phase. Therefore, a total current flowing in the entire channels is 80 mA, which is twice the current flowing in one channel. Thus, the amount of change in the power current I_{TOT} is 0 mA. Thus, the changing amount of the power current is reduced by 100% compared to that when the channels are simultaneously driven.

FIG. 6C shows a case where the duty ratio is 5/8. When a waveform of the first channel current I_{CH1} descends, a waveform of the second channel current I_{CH2} rises, and when a waveform of the second channel current I_{CH2} descends, a waveform of the third channel current I_{CH3} rises. When a waveform of the third channel current I_{CH3} descends, a waveform of the fourth channel current I_{CH4} rises. If the current flowing in one channel is 40 mA, a total current flowing in the entire channels is 120 mA in first 1/2 period and 80 mA in the remaining 1/2 period since the duty ratio is 5/8 and the number of the channels is four. Therefore, the amount of change in the power current I_{TOT} is 40 mA. Thus, the amount of change in the power current is reduced by 75% compared to that when the channels are simultaneously driven.

FIG. 6D shows a case where the duty ratio is 9/10. When a waveform of the first channel current I_{CH1} descends, a waveform of the second channel current I_{CH2} rises, and when a waveform of the second channel current I_{CH2} descends, a waveform of the third channel current I_{CH3} rises. When a waveform of the third channel current I_{CH3} descends, a waveform of the fourth channel current I_{CH4} rises. If the current flowing in one channel is 40 mA, a total current flowing in the entire channels is 160 mA in first 6/10 periods and 120 mA in the remaining 4/10 periods since the duty ratio is 9/10 and the number of the channels is four. Therefore, the amount of change in the power current I_{TOT} is 40 mA. Thus, the amount of change in the power current is reduced by 75% compared to that when the channels are simultaneously driven.

As described above, when the four channels are driven differentially according to example embodiments of inventive concepts, the amount of change in the power current or the ripple is reduced compared to the case when the channels are driven simultaneously.

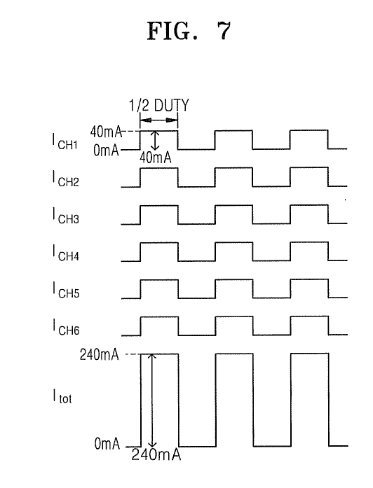

FIG. 7 is a timing diagram showing operations of an LED driving system when six channels are simultaneously driven.

Referring to FIG. 7, currents flowing in each of the channels and an amount of change in a power current according to the currents are shown. The duty ratio of the square wave current I_{CH1} through I_{CH6} flowing in the channels is 1/2. Since the brightness of the channels is adjusted in the PWM dimming controlling method, the current flowing in each of the channels also has a PWM square waveform. If the current flowing in a channel is 40 mA, a total current I_{TOT} flowing in the entire channels is 240 mA for first 1/2 period and 0 mA in the remaining 1/2 periods since the duty ratio is 1/2 and the number of the channels is six. Since the first through sixth dimming signals having the same frequency and the same duty ratio are activated at the same time due to the simultaneous driving of the channels, the currents simultaneously flow in the first through sixth channels. Therefore, the amount of change in the power current I_{TOT} is 240 mA regardless of the duty ratio.

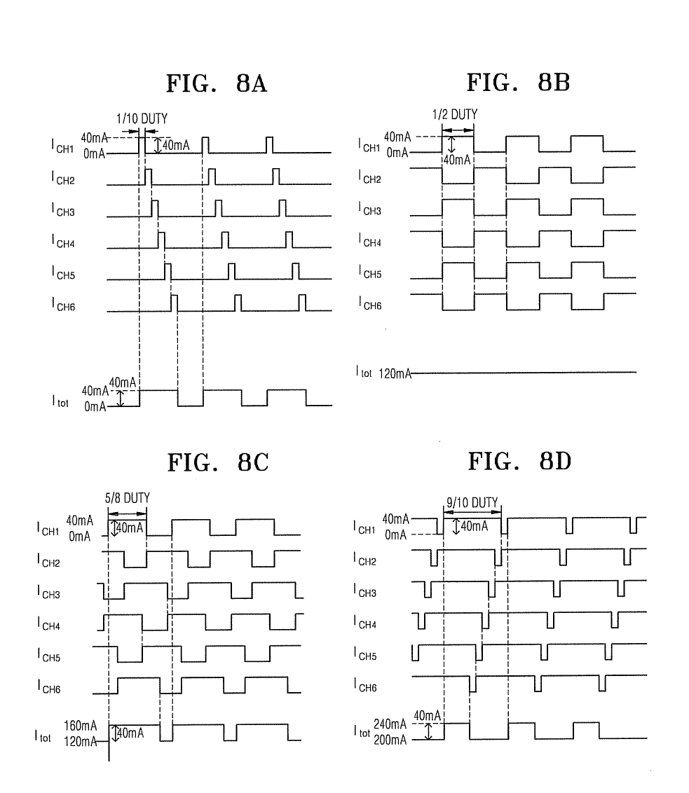

FIGS. 8A through 8D are timing diagrams showing operations of an LED driving system when six channels are sequentially driven, according to example embodiments of inventive concepts.

Referring to FIGS. 8A through 8D, current flowing in each of the channels and a changing amount of the power current according to the currents are shown. In FIGS. 8A through 8D, a duty ratio of square wave currents I_{CH1} through I_{CH6} flowing in the six channels is 1/10 (FIG. 8A), 1/2 (FIG. 8B), 5/8 (FIG. 8C), or 9/10 (FIG. 8D), for example. Since the brightness of the channels is adjusted in the PWM dimming controlling method, the current flowing in each of the channels also has a PWM square waveform. The first through sixth dimming signals having the same frequency and the same duty ratio and a phase difference as much as the duty ratio due to the differential driving of the channels, and thus, the waveforms of the currents flowing in the first through sixth channels also have a phase difference as much as the duty ratio.

FIG. 8A shows a case where the duty ratio is 1/10. When a waveform of the first channel current I_{CH1} descends, a waveform of the second channel current I_{CH2} rises, and when a waveform of the second channel current I_{CH2} descends, a waveform of the third channel current I_{CH3} rises. When a waveform of the third channel current I_{CH3} descends, a waveform of the fourth channel current I_{CH4} rises, and when a waveform of the fourth channel current I_{CH4} descends, a waveform of the fifth channel current I_{CH5} rises. When a waveform of the fifth channel current I_{CH5} is descends, a waveform of the sixth channel current I_{CH6} rises. If the current flowing in one channel is 40 mA, a total current flowing in the entire channels is 40 mA in first 6/10 periods and 0 mA in the remaining 4/10 periods since the duty ratio is 1/10 and the number of the channels is six. Therefore, the amount of change in the power current I_{TOT} is 40 mA. Thus, the amount of change in the power current is reduced to 40 mA from 240 mA when the channels are driven simultaneously, that is, by 83.33%.

FIG. 8B shows a case where the duty ratio is 1/2. When a waveform of the first channel current I_{CH1} descends, a waveform of the second channel current I_{CH2} rises, and when a waveform of the second channel current I_{CH2} descends, a waveform of the third channel current I_{CH3} rises. When a waveform of the third channel current I_{CH3} descends, a waveform of the fourth channel current I_{CH4} rises, and when a waveform of the fourth channel current I_{CH4} descends, a waveform of the fifth channel current I_{CH5} rises. When a waveform of the fifth channel current I_{CH5} descends, a waveform of the sixth channel current I_{CH6} rises. When a waveform of the fifth channel current I_{CH5} descends, a waveform of the sixth channel current I_{CH6} rises. When a waveform of the fifth channel current I_{CH5} descends, a waveform of the sixth channel current I_{CH6} rises. If the current flowing in one channel is 40 mA, the duty ratio is 1/2 and the number of channels is six, and accordingly, waveforms of the currents flowing in odd-numbered channels or in even-numbered channels have the same phases. Therefore, a total current flowing in all channels is 120 mA, which three times larger than the current flowing in one channel. Thus, the amount of change in the power current I_{TOT} is 0 mA. Thus, the amount of change in the power current is reduced by 100% compared to the case when the channels are simultaneously driven

FIG. 8C shows a case where the duty ratio is 5/8. When a waveform of the first channel current I_{CH1} descends, a waveform of the second channel current I_{CH2} rises, and when a waveform of the second channel current I_{CH2} descends, a waveform of the third channel current I_{CH3} rises. When a waveform of the third channel current I_{CH3} descends, a waveform of the fourth channel current I_{CH4} rises, and when a waveform of the fourth channel current I_{CH4} descends, a waveform of the fifth channel current I_{CH5} rises. When a waveform of the fifth channel current I_{CH5} descends, a waveform of the sixth channel current I_{CH6} rises. If the current flowing in one channel is 40 mA, a total current flowing in the entire channels is 160 mA in first 3/4 period and 120 mA in the remaining 1/4 period since the duty ratio is 5/8 and the number of the channels is six. Therefore, the amount of change in the power current I_{TOT} is 40 mA. Thus, the amount of change in the power current is reduced by 83.3% compared to the case when the channels are driven simultaneously.

FIG. 8D shows a case where the duty ratio is 9/10. When a waveform of the first channel current I_{CH1} descends, a waveform of the second channel current I_{CH2} rises, and when a waveform of the second channel current I_{CH2} descends, a waveform of the third channel current I_{CH3} rises. When a waveform of the third channel current I_{CH3} descends, a waveform of the fourth channel current I_{CH3} rises, and when a waveform of the fourth channel current I_{CH4} descends, a waveform of the fifth channel current I_{CH5} rises. When a waveform of the fifth channel current I_{CH5} descends, a waveform of the sixth channel current I_{CH6} rises. If the current flowing in one channel is 40 mA, a total current flowing in the entire channels is 240 mA in first 2/5 periods and 200 mA in the remaining 3/5 periods since the duty ratio is 9/10 and the number of the channels is six. Therefore, the amount of change in the power current I_{TOT} is 40 mA. Thus, the amount of change in the power current is reduced by 83.33% compared to the case when the channels are driven simultaneously.

As described above, when the six channels are driven differentially according to example embodiments of inventive concepts, the amount of change in the power current or the ripple is less than that when the channels are driven simultaneously.

According to the differential driving of the channels in example embodiments of inventive concepts, the phase difference between the channels may vary depending on the pulse width or the duty ratio at every period.

Example embodiments of inventive concepts are not limited to the number of channels and duty ratios described above, and may, for example, have varying numbers of channels and/or duty ratios.

In addition, according to the multi-channel differential driving in example embodiments of inventive concepts, the phase difference between the channels may be changed at every period according to dimming information regardless of the number of channels. An output of each of the channels is determined with reference to the dimming information transmitted externally. The dimming information may be transferred via the PWM signal. In this case, the pulse width or the duty ratio of the PWM signal may be different at every period, and thus, the phase difference between the channels may be different at every period. The first channel may be activated or deactivated in response to the PWM signal externally transmitted. Other channels may be activated in response to outputs of the deactivated channels.

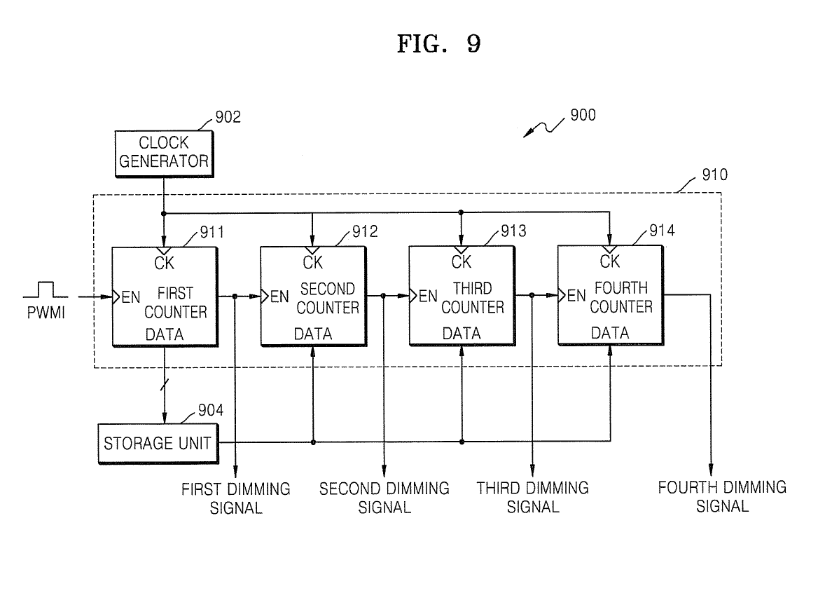

FIG. 9 is a block diagram of an LED driving unit shown in FIG. 2, according to example embodiments of inventive concepts.

Referring to FIG. 9, the LED driving unit 900 includes a clock generator 902 generating a reference clock, a storage unit 904 storing externally received dimming information, and a channel driving unit 910 outputting four dimming signals (first through fourth dimming signals). When a dimming resolution is k (where k is natural number that is equal to or greater than 1) bits, the storage unit 904 may have a capacity of at least k bits. The dimming information may be transferred via the PWM signal PWMI. In this case, a reference frequency may at least 2 k times greater than a frequency of the PWM signal PWMI.

For example, a first counter 911 is activated or deactivated in response to the PWM signal PWMI. Here, the first counter 911 may be activated or deactivated in response to a level transition of the PWM signal PWMI. For example, an output of the first counter 911 is activated in response to a rising edge of the PWM signal PWMI, and is deactivated in response to a descending edge of the PWM signal PWMI. The activated first counter 911 counts a number of reference clock cycles to detect the pulse width or the duty ratio of the PWM signal PWMI. The number of reference clock cycles which represents the detected pulse width or the duty ratio is stored in the storage unit 904. The storage unit 904 is reset in every period of the PWM signal PWMI to store the newly detected pulse width or duty ratio of the PWM signal PWMI at every period. A second counter 912 is activated in response to the output of the first counter 911. Here, the second counter 912 may be activated in response to a level transition of the output from the first counter 911. For example, an output of the second counter 912 may be activated in response to a descending edge of the output from the first counter 911. The activated second counter 912 counts the reference clock cycles with reference to the value stored in the storage unit 904. When the count number of the reference clock cycles reaches the value stored in the storage unit 904, the second counter 912 is deactivated. Therefore, the first counter 911 and the second counter 912 may generate PWM signals (first and second dimming signals) having the same frequency and the same pulse with as those of the PWM signal and output the generated signals. A third counter 913 and a fourth counter 914 may operate based on the same mechanism as the second counter 912 except that the third counter 913 and the fourth counter 914 are activated in response to outputs of the second counter 912 and the third counter 913, respectively. The first counter 911 detects the pulse width of the PWM signal PWMI, and the other counters 912 to 914 may generate dimming signals (first through fourth dimming signals) having the same pulse width as that of the PWM signal PWMI with reference to the pulse width of the PWM signal PWMI detected by the first counter 911.

The channel driving unit 910 includes the four counters 911 to 914 corresponding to four channels. The first counter 911 outputs the first dimming signal upon receiving the PWM signal PWMI applied from the outside, and at the same time, detects the pulse width of the PWM signal PWMI. However, besides the four counters 911 to 914 corresponding to the four channels, a counter (not shown) for receiving the PWM signal PWMI and detecting the pulse width of the PWM signal PWMI may be further included in the channel driving unit 910. For example, the LED driving unit having n channels may include n+1 counters, one of which may detect the pulse width of the PWM signal PWMI applied from the outside and does not output a dimming signal. The remaining n counters may output the dimming signals for driving the n channels.

The LED driving unit 900 of FIG. 9 includes four channels, however, the number of channels is not limited thereto, according to example embodiments of inventive concepts.

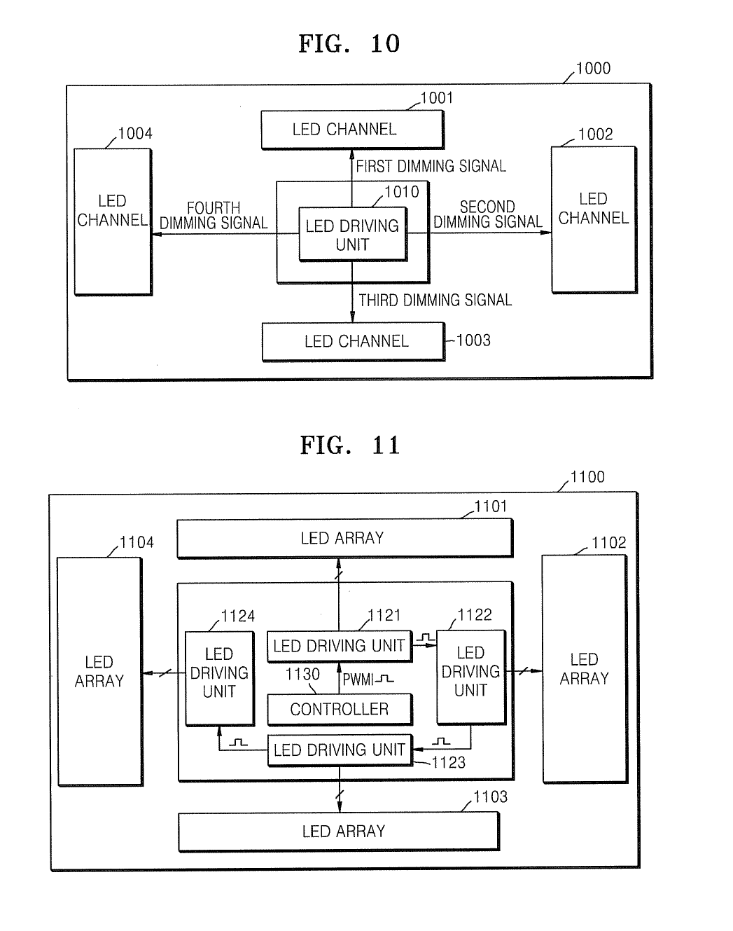

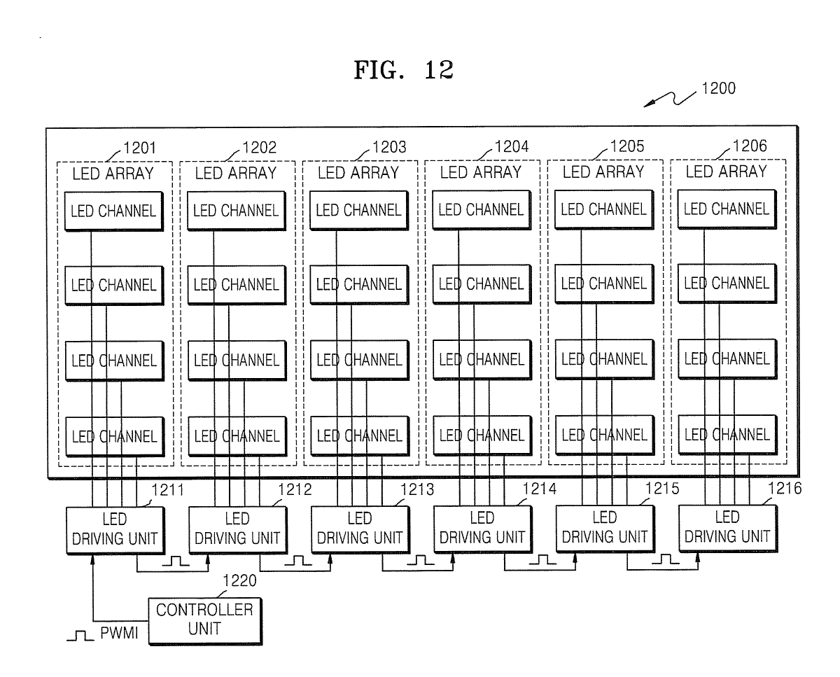

In general, a backlight unit using an LED may be classified as an edge-type backlight unit or a direct-type backlight unit according to the location of a light source. FIGS. 10 and 11 show an edge-type backlight unit, in which an LED light source is located on a side of a light guide plate (not shown) to radiate light toward a front surface of a liquid crystal panel through the light guide plate. FIGS. 12 through 14 show a direct-type backlight unit, in which an LED light source having nearly the same area as a liquid crystal panel is located right under the liquid crystal panel to directly emit light to a front surface of the liquid crystal panel. In general, monitors of notebook computers and LCD monitors include an edge-type backlight which has low brightness smear, thin thickness, and low power consumption. The direct-type backlight is also widely used in large screen LCDs due to advantages such as high optical usage rate, easiness in handling, and no limitation in display surface. When the direct-type backlight is used in the LCD having a large screen such as a large LCD television, the LCD is divided into a plurality of sections, each of which includes LEDs on a substrate that configure a backlight driving system.

FIG. 10 is a diagram of an LED backlight unit including the LED driving system of FIG. 2, according to example embodiments of inventive concepts, where the LED driving system 200 of FIG. 2 is used as a backlight of an LCD.

Referring to FIG. 10, the LED backlight unit 1000 includes a power unit (not shown), four LED channels 1001, 1002, 1003, and 1004, an LED driving unit 1010 driving the four LED channels 1001 to 1004, and a controller (not shown) controlling the LED driving unit 1010. Each of the LED channels 1001 to 1004 may include a plurality of LEDs connected in series. The controller (not shown) generates dimming information for controlling the LED driving unit 1010, and the LED driving unit 1010 outputs dimming signals to the LED channels 1001 to 1004 according to the dimming information provided from the controller (not shown). The dimming information may be transferred via a PWM signal. The LED driving unit 1010 sequentially shifts a phase of the PWM signal transmitted from the controller (not shown) as much as a pulse width of the PWM signal to generate four dimming signals, and outputs the generated dimming signals to the corresponding LED channels 1001 to 1004. The LED channels 1001 to 1004 emit light of constant brightness according to an average current amount that is determined by the dimming signals provided from the LED driving unit 1010. As the light emitted from the LED channels 1001 to 1004, which are driven by the LED driving unit 1010, transmit through a liquid crystal panel, images are displayed on the LCD.

For example, the controller (not shown) transmits the PWM signal including the dimming information to the LED driving unit 1010. The LED driving unit 1010 detects the pulse width or duty ratio of the PWM signal, and sequentially shifts the phase of the PWM signal as much as the detected pulse width or duty ratio to generate the four dimming signals (first through fourth dimming signals). The PWM signal received from the controller (not shown) may be used as a first dimming signal. The second dimming signal has a phase difference from the first dimming signal as much as the detected pulse width or duty ratio. Likewise, the third dimming signal has a phase difference from the second dimming signal as much as the detected pulse width or duty ratio. The fourth dimming signal has a phase difference from the third dimming signal as much as the detected pulse width or duty ratio. Therefore, the phase difference between the dimming signals of two adjacent channels may vary according to the pulse width or duty ratio of the PWM signal at every period. In addition, the four dimming signals may have the same frequency and duty ratio as the PWM signal.

The four LED channels 1001 to 1004 respectively include a plurality of LEDs connected in series, or in parallel and in series. In order to improve uniformity of the currents flowing in the channels 1001 to 1004, the LED channels 1001 to 1004 may include the same number of LEDs having the same properties. The LED may be a white LED, or a package of red (R), green (G), and blue (B) LEDs. When the package of RGB LEDs are used, brightness characteristics of the RGB LEDs may be different from each other, and accordingly, separate LED driving units for red LEDs, blue LEDs, and green LEDs may be used, according to example embodiments of inventive concepts.

FIG. 11 is a another diagram of an LED backlight unit including the LED driving system of FIG. 2, according to example embodiments of inventive concepts, where the LED driving system 200 is used as a backlight of an LCD.

Referring to FIG. 11, the LED backlight unit 1100 includes four LED arrays 1101, 1102, 1103, and 1104, each of which includes four channels, a power unit (not shown) supplying electric current to the LED arrays 1101, 1102, 1103, and 1104, four LED driving units 1121, 1122, 1123, and 1124 for driving the four LED arrays 1101 to 1104, and a controller 1130 controlling the LED driving units 1121 to 1124. Each of the LED driving units 1121 to 1124 sequentially shifts a phase of the PWM signal transmitted from outside as much as a pulse width of the PWM signal to generate four dimming signals, and outputs the generated dimming signals to the corresponding LED arrays 1101 to 1104.

The LED backlight unit 110 is different from the backlight unit 1000 of FIG. 10 in that there are a plurality of LED arrays and a plurality of LED driving units. When the plurality of LED driving units 1121 to 1124 output the dimming signals having the same pulse width or duty ratio, one LED driving unit may receive the dimming information from the controller 1130. In this case, the other LED driving units may receive the dimming information from the LED driving unit which receives the dimming information from the controller 1130. The dimming information may be transferred via the PWM signal.

For example, the first LED driving unit 1121 receives the PWM signal PWMI from the controller 130 to receive the dimming information, and is activated or deactivated in response to the PWM signal PWMI. The second LED driving unit 1122 may be activated on receiving the dimming information from the first LED driving unit 1121. In this case, the signal received by the second LED driving unit 1122 may be a dimming signal output from the fourth channel in the first LED driving unit 1121. Likewise, the third LED driving unit 1123 may be activated on receiving the dimming information from the second LED driving unit 1122. In this case, the signal received by the third LED driving unit 1123 may be a dimming signal output from a fourth channel of the second LED driving unit 1122. That is, an n-th LED driving unit may receive the dimming information from an (n−1)th LED driving unit to be activated. Then, the signal received by the n-th LED driving unit may be the dimming signal output from the last channel of the (n−1)th LED driving unit. Therefore, the four LED driving units 1121 to 1124 may be operated as one LED driving unit having 4×4=16 channels.

In addition, although it is not shown in FIG. 11, the four LED arrays 1101 to 1104 may share the same power unit (not shown), or each of the LED arrays 1101 to 1104 may separately include a power unit (not shown). When the LED arrays 1101 to 1104 share the same power unit, the four LED driving units 1121 to 1124 are sequentially activated and operated as described above. When the LED arrays 1101 to 1104 separately include power units, the LED driving units 1121 to 1124 may be activated simultaneously and/or operated independently.

FIG. 12 is yet another diagram of an LED backlight unit including the LED driving system of FIG. 2, according to example embodiments of inventive concepts, where, where the LED driving system 200 is used as a backlight in an LCD.

Referring to FIG. 12, the LED backlight unit 1200 includes six LED arrays 1201, 1202, 1203, 1204, 1205, and 1206, a power unit (not shown) supplying electric current to the LED arrays 1201 to 1206, six LED driving units 1211, 1212, 1213, 1214, 1215, and 1216, and a controller 1220 controlling the LED driving units 1211 to 1216. Each of the six LED arrays 1201 to 1206 includes four LED channels. Each of the LED driving units 1211 to 1216 sequentially shifts a phase of a PWM signal externally received as much as a pulse width of the PWM signal to generate four dimming signals, and output the generated dimming signals to the corresponding LED channels.

If the backlight is a direct-type backlight unit, the plurality of LED arrays 1201 to 1206 generally include more LEDs than the edge-type backlight unit in order to radiate light uniformly to a rear surface of the liquid crystal panel, and thus, the backlight may include one or more LED driving units. The controller 1220 transmits dimming information to the LED driving units 1211 to 1216. The dimming information may be transferred via a PWM signal. When the plurality of LED driving units 1211 to 1216 output the dimming signals having the same duty ratio, one of the LED driving units may receive the PWM signal from the controller 1220.

For example, the controller 1220 generates the dimming information and transfers the dimming information to the PWM signal PWMI, which is then transmitted to the first LED driving unit 1211. In this case, the other LED driving units 1212 to 1216 may receive the dimming information from the LED driving unit 1211, which receives the dimming information from the controller 1220. For example, the first LED driving unit 1211 receives the PWM signal PWMI from the controller 1220 to obtain the dimming information, and is activated or deactivated in response to the PWM signal PWMI. The second LED driving unit 1212 may be activated on receiving the dimming information from the first LED driving unit 1211. In this case, the signal received by the second LED driving unit 1212 may be the dimming signal output from a fourth channel of the first LED driving unit 1211. Likewise, the third LED driving signal 1213 may be activated on receiving the dimming information from the second LED driving unit 1212. In this case, the signal received by the third LED driving unit 1213 may be the dimming signal output from a fourth channel of the second LED driving unit 1212. That is, an n-th LED driving unit may receive the dimming information from an (n−1)th LED driving unit to be activated. Then, the signal received by the n-th LED driving unit may be the dimming signal output from the last channel of the (n−1)th LED driving unit. Therefore, the six LED driving units 1211 to 1216 may be operated as one LED driving unit having 4×6=24 channels.

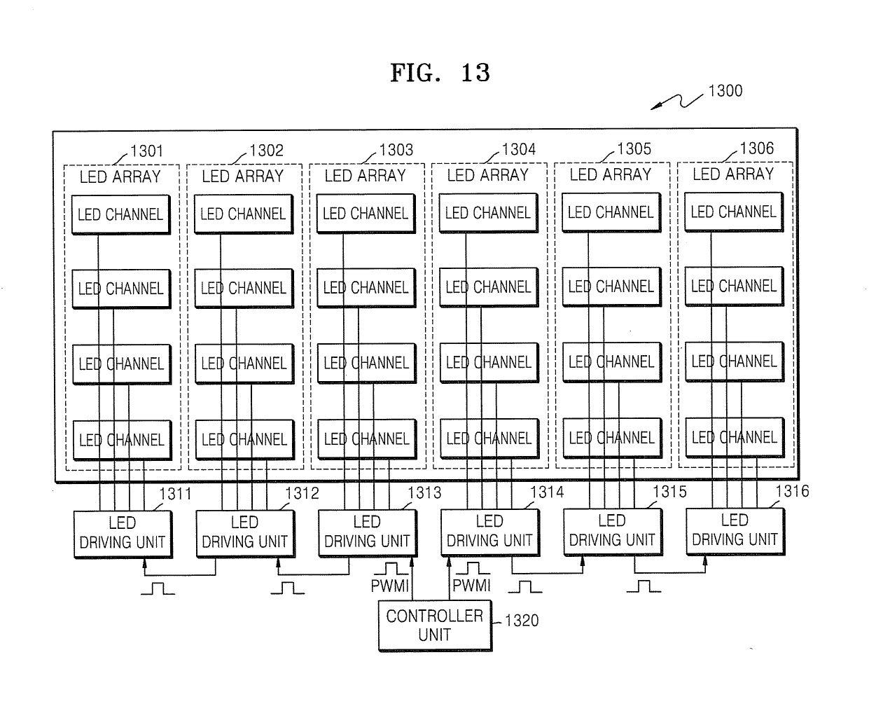

FIG. 13 is still another diagram of an LED backlight unit including the LED driving system of FIG. 2, according to example embodiments of inventive concepts, where the LED driving system 200 of FIG. 2 is used as a backlight of an LCD.

Referring to FIG. 13, the LED backlight unit 1300 includes six LED arrays 1301, 1302, 1303, 1304, 1305, and 1306, a power unit (not shown) supplying electric current to the LED arrays 1301 to 1306, six LED driving units 1311, 1312, 1313, 1314, 1315, and 1316, and a controller 1320 controlling the LED driving units 1311 to 1316. Each of the six LED arrays 1301 to 1306 includes four LED channels. Each of the LED driving units 1310 to 1316 sequentially shifts a phase of the PWM signal externally received as much as a pulse width of the PWM signal to generate four dimming signals, and outputs the generated dimming signals to the corresponding LED channels.

The LED backlight unit 1300 of FIG. 13 is different from the LED backlight unit 1200 of FIG. 12 in view of structures of the LED driving units 1311 to 1316 receiving the dimming information.

For example, the six LED driving units 1311 to 1316 are divided into two groups (a group including the LED driving units 1311 to 1313, and a group including the LED driving units 1314 to 1316), and each of the groups receives the dimming information from the controller 1320 separately from each other. In each group, the third LED driving unit 1313 or the fourth LED driving unit 1314 directly receives the PWM signal PWMI from the controller 1320 to obtain the dimming information, and transfers the dimming information to the other LED driving units in that group. The dimming information may be transferred via the PWM signal.

For example, the third LED driving unit 1313 receives the PWM signal PWMI from the controller 1320 to obtain the dimming information, and is activated or deactivated in response to the PWM signal PWMI. The second LED driving unit 1312 may be activated on receiving the dimming information from the third LED driving unit 1313. In this case, the signal received by the second LED driving unit 1312 may be the dimming signal output from a fourth channel of the third LED driving unit 1313. Likewise, the first LED driving unit 1311 may be activated on receiving the dimming information from the second LED driving unit 1312. In this case, the signal received by the LED driving unit 1311 may be the dimming signal output from a fourth channel of the second LED driving unit 1312.

On the other hand, the fourth LED driving unit 1314 receives the PWM signal PWMI from the controller 1320 to obtain the dimming information, and is activated or deactivated in response to the PWM signal PWMI. The fifth LED driving unit 1315 may be activated on receiving the dimming information from the fourth LED driving unit 1314. In this case, the signal received by the fifth LED driving unit 1315 may be the dimming signal output from a fourth channel of the fourth LED driving unit 1314. Likewise, the sixth LED driving unit 1316 may be activated on receiving the dimming information from the fifth LED driving unit 1315. In this case, the signal received by the sixth LED driving unit 1316 may be the dimming signal output from a fourth channel of the fifth LED driving unit 1315.

In addition, the dimming information, that is, the PWM signals, transmitted to the third LED driving unit 1313 and the fourth LED driving unit 1314 from the controller 1320 may be different from each other.

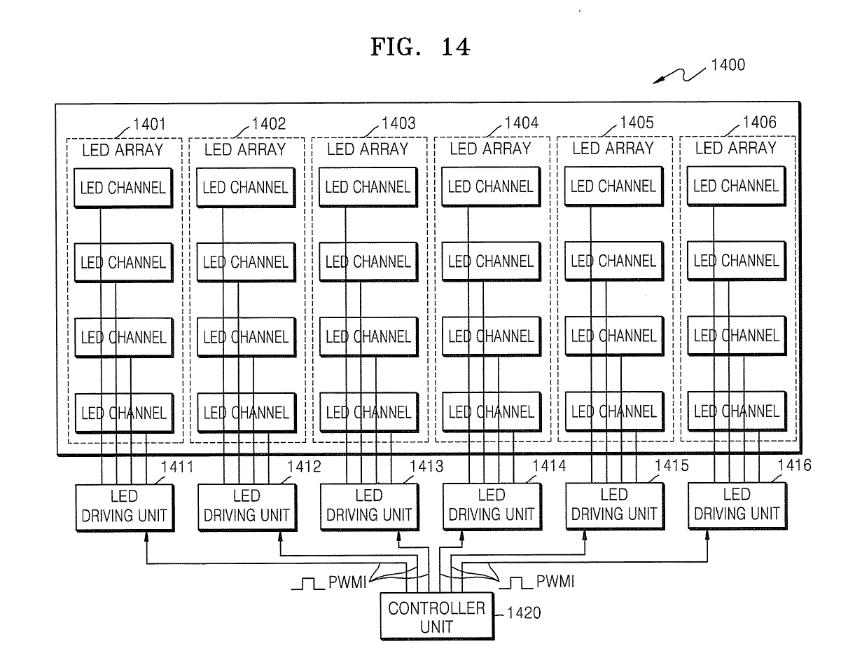

FIG. 14 is yet another diagram of an LED backlight unit including the LED driving system of FIG. 2, according to example embodiments of inventive concepts, where the LED driving system 200 is used as a backlight of an LCD.

Referring to FIG. 14, the LED backlight unit 1400 includes six LED arrays 1401, 1402, 1403, 1404, 1405, and 1406, a power unit (not shown) supplying electric current to the LED arrays 1401 to 1406, six LED driving units 1411, 1412, 1413, 1414, 1415, and 1416, and a controller 1420 controlling the LED driving units 1411 to 1416. Each of the six LED arrays 1401 to 1406 includes four LED channels. Each of the LED driving units 1410 to 1416 sequentially shifts a phase of the PWM signal received externally as much as a pulse width of the PWM signal to generate four dimming signals, and outputs the generated dimming signals to the corresponding LED channels. The above described operations are similar to those of the LED backlight units 1200 and 1300 shown in FIGS. 12 and 13. However, the controller 1420 in FIG. 14 generates dimming information for each of the six LED arrays 1401 to 1406, and directly transmits the dimming information to the corresponding LED driving units 1411 to 1416. Thus, the LED backlight unit 1400 of FIG. 14 is different from the LED backlight units 1200 and 1300 of FIGS. 12 and 13. For example, in the LED backlight unit 1400, the six LED driving units 1411 to 1416 receive the dimming information separately from each other, and output dimming signals having different pulse widths or duty ratios from each other. Therefore, each of the LED driving units 1411 to 1416 may be independently dimming-controlled. Each of the LED driving units 1411 to 1416 generates the dimming signal having a duty ratio corresponding to the transmitted dimming information, and outputs the dimming signal to the corresponding LED array. The dimming information may be transferred as the PWM signal. Each of the LED driving units 1411 to 1416 receives the PWM signal PWMI from the controller 1420 to obtain the dimming information. The dimming information received by each of the LED driving units 1411 to 1416 may be different from that of the others, and thus, the LED driving units 1411 to 1416 may output the dimming signals having different duty ratios. Therefore, the LED arrays 1404 to 1406 may emit lights of different brightness. In this case, the brightness may be adjusted in each region of the LCD according to the difference between locations of the LED arrays 1401 to 1406. Therefore, a dark portion may become darker, and a bright portion may become brighter, thereby improving an image quality. In addition, a brightness difference between regions caused by the uneven characteristics of the LED arrays 1401 to 1406 may be compensated, and accordingly, uniform brightness may be obtained throughout the entire regions of the LCD.

The six LED arrays 1401 to 1406 may share a power unit (not shown) supplying the power to the LED arrays 1401 to 1406, or may respectively include separate power units. When the six LED arrays 1401 to 1406 share the same power unit, the six LED driving units 1411 to 1416 are sequentially activated and operated. Thus, the six LED driving units 1411 to 1416 may operate as one LED driving unit having 24 channels. When each of the LED arrays 1401 to 1406 includes separate power units, the LED driving units 1411 and 1416 may be simultaneously activated and/or operated independently from each other.

In the LED backlight units 1000, 1100, 1200, 1300, and 1400 shown in FIGS. 10 through 14, the LED array includes four channels. However, example embodiments of inventive concepts are not limited thereto and may include various numbers of channels and/or LED arrays.

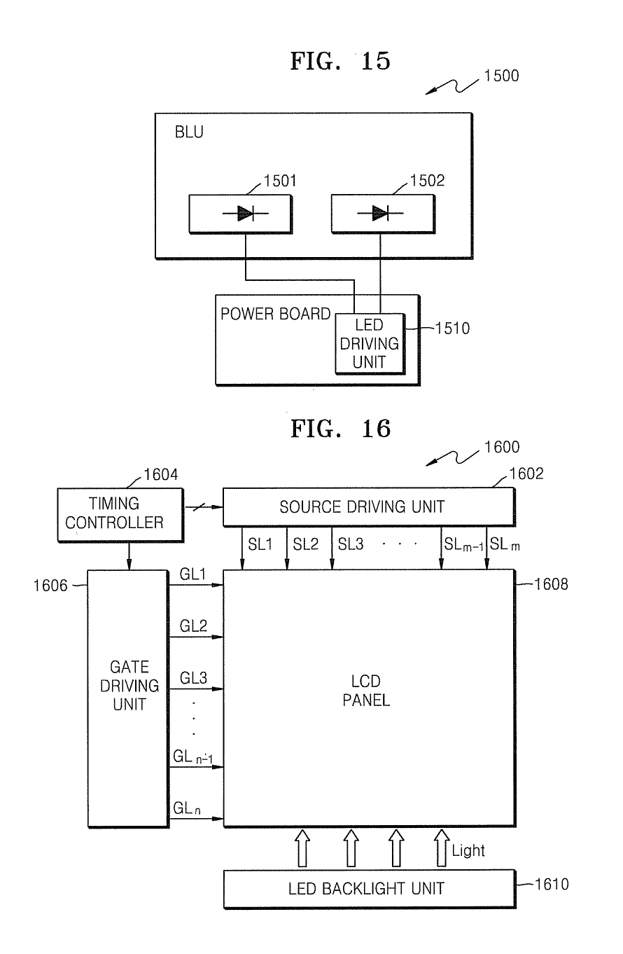

FIG. 15 is still another diagram of an LED backlight unit including the LED driving system of FIG. 2, according to example embodiments of inventive concepts, where the LED driving system 200 of FIG. 2 is used as a backlight in an LCD.

Referring to FIG. 15, the LED backlight unit 1500 includes two LED channels 1501 and 1502, each of which includes one LED device, a power unit (not shown) supplying electric current to the LED channels 1501 and 1502, an LED driving unit 1510 supplying a PWM dimming signal for controlling brightness of the LED channels to the LED channels 1501 and 1502, and a controller (not shown). The LED backlight unit 1500 uses one LED device per channel, and may be used as a backlight for a small LCD. The LED driving unit 1510 receives dimming information from the controller (not shown) and outputs the dimming signal having a pulse width or duty ratio which is determined according to the dimming information to each of the LED channels 1501 and 1502. The dimming information may be transferred by the PWM signal.

The LED driving unit 1510 sequentially shifts the PWM signal as much as the pulse width of the PWM signal to generate two dimming signals, and outputs the generated dimming signals to the corresponding LED channels 1501 and 1502. Thus, the two LED devices are not used as one channel by being connected to each other in series, but are used as two channels.

The LED backlight unit 1500 includes two LED devices which are sequentially driven. However, example embodiments of inventive concepts are not limited thereto and may include, for example, a various number of LED devices. For example, at least two LED devices may be classified as at least two groups that are sequentially driven.

FIG. 16 is a block diagram of an LCD according to example embodiments of inventive concepts.

Referring to FIG. 16, the LCD 1600 includes a timing controller 1604, a gate driving unit 1606, a source driving unit 1602, a liquid crystal panel 1608, and an LED backlight unit 1610. The timing controller 1604 generates a control signal for controlling the gate driving unit 1606 and the source driving unit 1602, and transmits externally received image signals to the source driving unit 1602. The gate driving unit 1606 and the source driving unit 1602 drive the liquid crystal panel 1608 according to the control signal provided from the timing controller 1604. The gate driving unit 1606 applies a scan signal sequentially to columns of the liquid crystal panel 1608, and thin film transistors (TFTs) connected to the column electrodes to which the scan signal is applied are sequentially turned on as the scan signal is applied. At this time, a gray-scale voltage is applied to the liquid crystal via the TFT of the column, to which the scan signal is applied, from the source driving unit 1602. The gray-scale voltage controls a rotary angle of the liquid crystal to adjust the light transmittance.

The LED backlight unit 1610 may be the LED backlight unit 1000, 1100, 1200, 1300, 1400, or 1500 according to the example embodiments of inventive concepts. Operations of the LED backlight unit 1610 are described with reference to FIGS. 10 through 15, and detailed descriptions about the operations are not provided here.

While inventive concepts have been particularly shown and described with reference to example embodiments thereof, it will be understood that various changes in form and details may be made therein without departing from the spirit and scope of the following claims.

1. A light emitting diode (LED) driving apparatus, comprising:
a channel driving unit configured to detect a pulse width of a pulse width modulation (PWM) signal, and configured to output n dimming signals, where n is a natural number greater than or equal to 2, wherein
the channel driving unit is configured to sequentially shift a phase of the PWM signal by as much as the detected pulse width to generate the n dimming signals, and configured to output the n dimming signals to n channels.

2. The LED driving apparatus of claim 1, wherein the channel driving unit is configured to detect the pulse width of the PWM signal by calculating a number of reference clock cycles during the pulse width of the PWM signal.

3. The LED driving apparatus of claim 2, where the channel driving unit comprises:
a storage unit configured to store the detected pulse width.

4. The LED driving apparatus of claim 3, wherein the channel driving unit further comprises:
n counters configured to generate and output the n dimming signals to the n channels, wherein
a first counter of the n counters is activated in response to the PWM signal,
an n-th counter of the n counters is activated in response to an output of an (n−1)th counter of the n counters, and
each of the sequentially activated first through n-th counters count the reference clock cycles up to a value stored in the storage unit and then deactivate.

5. The LED driving apparatus of claim 4, wherein the first counter is activated in response to a rising edge of the PWM signal, and the n-th counter is activated in response to a falling edge of the output from the (n−1)th counter.

6. The LED driving apparatus of claim 5, wherein the first counter receives the PWM signal, and detects the pulse width of the PWM signal, and outputs the PWM signal as a first dimming signal of the n dimming signals.

7. The LED driving apparatus of claim 2, further comprising:
a clock generator configured to supply the reference clock cycles.

8. The LED driving apparatus of claim 1, wherein the PWM signal is externally received.

9. The LED driving apparatus of claim 1, wherein each of the channels includes a plurality of LEDs connected in series.

10. An LED driving system comprising:
the LED driving apparatus of claim 1;
a plurality of LEDs connected in series to each of the n channels;
at least one switch configured to control a current flowing to the plurality of LEDs in response to the n dimming signals; and
a power unit configured to supply the current flowing to the plurality LEDs.

11. The LED driving system of claim 10, wherein the channel driving unit of the LED driving apparatus comprises:
a storage unit configured to store the pulse width of the PWM signal, where the pulse width of the PWM signal is detected by counting reference clock cycles; and
n counters configured to generate the n dimming signals and configured to output the n dimming signals to the n channels, wherein
a first counter of the n counters is activated in response to the PWM signal, an n-th counter of the n counters is activated in response to an output of an (n−1)th counter of the n counters, and at least one of the sequentially activated first through n-th counters counts the reference clock cycles up to a value stored in the storage unit and then deactivates.

12. The LED driving system of claim 11, wherein each of the sequentially activated first through n-th counters counts the reference clock cycles up to a value stored in the storage unit and then deactivate.

13. The LED driving apparatus of claim 12, wherein the first counter is activated in response to a rising edge of the PWM signal, and the n-th counter is activated in response to a falling edge of the output from the (n−1)th counter.

14. The LED driving apparatus of claim 13, wherein the first counter receives the PWM signal, and detects the pulse width of the PWM signal, and outputs the PWM signal as a first dimming signal of the n dimming signals.

15. The LED driving apparatus of claim 11, further comprising:
a clock generator configured to supply the reference clock cycles.

16-20. (canceled)
